(19) United States
(12) Patent Application Publication
(10) Pub. No.: US 2012/0086965 A1
(43) Pub. Date: Apr. 12, 2012

(54) Image forming apparatus, host apparatus and job performing method thereof

(75) Inventors: Kyung-hoon Kang, Suwon-si (KR); In-sung Choi, Seoul (KR)

(73) Assignee: SAMSUNG ELECTRONICS CO., LTD., Suwon-si (KR)

(21) Appl. No.: 13/067,159

(22) Filed: May 12, 2011

(30) Foreign Application Priority Data
Oct. 11, 2010 (KR) 10-2010-0098724

(51) Int. Cl. G06K 15/02

(52) U.S. Cl. 358/1.13; 358/1.15

(57) ABSTRACT

An imaging forming apparatus, host apparatus, and job performing method thereof, the job performing method using target setup in an image forming apparatus supporting at least one function for targeting one host apparatus of a plurality of host apparatuses connected to the image forming apparatus via a network, the method including: receiving, by the host apparatus, input of a user generating a job event using a function by target setup supported by the image forming apparatus; transmitting, by the host apparatus, a use request message corresponding to the job event to the image forming apparatus; receiving, by the host apparatus, a message about whether to make a registration including whether a job targeting the host apparatus is registered in response to the use request message from the image forming apparatus; and displaying whether the job event is registered based on the received message about whether to make the registration.

### CROSS-REFERENCE TO RELATED APPLICATIONS

This application claims priority from Korean Patent Application No. 10-2010-0098724, filed on Oct. 11, 2010 in the Korean Intellectual Property Office, the disclosure of which is incorporated herein by reference.

### BACKGROUND

1. Field

Apparatuses consistent with the exemplary embodiments relate to an image forming apparatus, a host apparatus and a job performing method thereof, and more particularly, to an image forming apparatus which performs a job by target setup in the image forming apparatus to support at least one function for one target among a plurality of host apparatuses, a host apparatus, and a job performing method thereof.

2. Description of the Related Art

A network image forming apparatus is connected to a plurality of personal computers (PCs), which are host apparatuses, via a network and supports a function of transmitting job data with respect to a function to a target host apparatus desired by a user based on a communication protocol.

For example, an image forming apparatus supporting a scan-to-PC performs a job of transmitting image data generated by a scan to a target host apparatus, and an image forming apparatus supporting a screen print performs a job of receiving and printing an image generated by capturing a screen of a target host apparatus.

When the image forming apparatus performing a job by target setup in the network selects a function to perform, such as a scan-to-PC and a screen print, and selects a target host apparatus among a plurality of host apparatuses connected via a network using a liquid crystal display (LCD) panel and an input button provided in the image forming apparatus, image data generated by a scanning process is transmitted to the selected target host apparatus, or a screen image of the target host apparatus is transmitted to the image forming apparatus, and then the job is performed.

Thus, it is impossible to set up a target when the network image forming apparatus does not have an LCD panel, so that a function which involves the target setup may not be used.

Further, in order to set up a target using an LCD panel, the user may identify a host apparatus based on limited information, such as an IP address and port information displayed on the LCD panel. Also, since limited input buttons are provided in the image forming apparatus so that manipulation may be complicated, the user which is unfamiliar with a network multiple user environment may have difficult in finding a proper target, causing inconvenience for the user.

Moreover, a host apparatus which is not registered previously in the image forming apparatus first conducts a complicated registration process to use a corresponding function.

A screen print function outputs a screen image of a host apparatus, and thus the screen print function may not be used in a network image forming apparatus, unlike an image forming apparatus connected locally, such as, via a universal serial bus (USB).

### SUMMARY

Accordingly, one or more exemplary embodiments provide an image forming apparatus, a host apparatus, and a job performing method thereof, in which the image forming apparatus determines whether use is allowed based on a use request of a host apparatus to perform a job by target setup and transmits job data to the target host apparatus, so that a manipulation for target setup is not necessary in the image forming apparatus,. Thus, a function using target setup may be simply used even in an image forming apparatus which does not have an LCD panel or includes a minimum number of input buttons.

Further, an image forming apparatus, a host apparatus, and a job performing method thereof is provided in which a target host apparatus is selected through a manipulation of a user-friendly host apparatus, and thus a user unfamiliar with a multiple user environment easily uses a function by target setup, and a host apparatus, even not pre-registered, is allowed to set up a target, improving convenience of users.

Further, an image forming apparatus, a host apparatus, and a job performing method thereof is provided which allow a screen print to be used in a network environment.

The foregoing and/or other aspects may be achieved by providing a job performing method using target setup in an image forming apparatus supporting at least one function for targeting one host apparatus of a plurality of host apparatuses connected to the image forming apparatus via a network, the method including: receiving, by the host apparatus, input of a user generating a job event using a function by target setup supported by the image forming apparatus; transmitting, by the host apparatus, a use request message corresponding to the job event to the image forming apparatus; receiving, by the host apparatus, a message about whether to make a registration including whether a job targeting the host apparatus is registered in response to the use request message from the image forming apparatus; and displaying, by the host apparatus, whether the job event is registered based on the received message about whether to make the registration.

The use request message may include at least one a job type, user information, an IP address of the host apparatus, port information, a number of jobs, and a requested using time.

The function by target setup may include at least one of a scan-to-PC and a screen print.

The method may further include displaying, by the host apparatus, a notification window to ask about whether to reserve the job when the job is unregisterable.

The method may further include receiving, by the host apparatus, a selection of the user in response to the notification window to ask about whether to reserve the job; and transmitting, by the host apparatus, a reservation request message to the image forming apparatus based on the selection of the user.

The foregoing and/or other aspects may be achieved by providing a job performing method using target setup in an image forming apparatus supporting at least one function for targeting one host apparatus of a plurality of host apparatuses connected to the image forming apparatus via a network, the method including: receiving, by the image forming apparatus, a use request message corresponding to a job event using a function by target setup supported by the image forming apparatus from the host apparatuses; determining, by the image forming apparatus, whether a job targeting the host apparatus is registerable corresponding to the received use request message; transmitting, by the image forming apparatus, a message about whether to make a registration including whether the job is registered to the host apparatus based on a result of the determination.

The method further include storing, by the image forming apparatus, information about a registered job when the job is registerable, wherein the information about the registered job includes at least one of a job type, an IP address of the host apparatus, port information, registered time, a requested using time, a total number of jobs, a number of remaining jobs, and whether a job is performed and the information about the reserved job is updated based on whether the job is performed.

The method may further include receiving, by the image forming apparatus, the reservation request message when the job is not registerable; and storing, by the image forming apparatus, information about a reserved job corresponding to the received reservation request message; and the information about the reserved job may include at least one of a job type, an IP address of the host apparatus, port information, registered time, a requested using time, a total number of jobs, a number of remaining jobs, and whether a job is performed and the information about the reserved job may be updated based on whether the job is performed.

The method may further include transmitting a job event corresponding to the registered job and performing a corresponding job.

The method may further include transmitting, by the image forming apparatus, a use allowed message to the host apparatus corresponding to the reserved job when performance of the registered job terminates.

The method may further include transmitting, by the image forming apparatus, a use allowed message to the host apparatus corresponding to the reserved job when a requested using time of the registered job is over.

The foregoing and/or other aspects may be achieved by providing a host apparatus connected via a network to an image forming apparatus supporting at least one function for targeting one of a plurality of host apparatuses, the host apparatus including: a communication unit which performs network communication with the image forming apparatus; a user input unit which receives input of a user generating a job event using a function by target setup supported by the image forming apparatus; a display unit; and a controller which transmits a use request message corresponding to the job event to the image forming apparatus, controls the communication unit to receive, from the image forming apparatus, a message about whether to make a registration including whether a job targeting the host apparatus is registered in response to the use request message, and controls the display unit to display whether the job event is registered based on the received message about whether to make the registration.

The use request message may include at least one a job type, user information, an IP address of the host apparatus, port information, a number of jobs, and a requested using time.

The function by target setup may include at least one of a scan-to-PC and a screen print.

The display unit may display a notification window to ask about whether to reserve the job when the job is unregisterable, the user input unit may receive a selection of the user in response to the notification window to ask about whether to reserve the job, and the controller may control the communication unit to transmit a reservation request message to the image forming apparatus based on the selection of the user.

The foregoing and/or other aspects may be achieved by providing an image forming apparatus supporting at least one function for targeting one of a plurality of host apparatuses and performing network communication with the plurality of host apparatuses, the image forming apparatus including: a communication unit which receives, from the host apparatuses, a use request message corresponding to a job event using a function by target setup supported by the image forming apparatus; and a controller which determines whether a job targeting the host apparatuses is registerable corresponding to the received use request message, and controls the communication unit to transmit, to the host apparatuses, a message about whether to make a registration including whether the job is registered based on a result of the determination.

The image forming apparatus may further include a storage unit to store job information, and the controller may store information about a registered job corresponding to the received use request message in the storage unit when the job is registerable.

The information about the registered job may include at least one of a job type, an IP address of the host apparatuses, port information, registered time, a requested using time, a total number of jobs, a number of remaining jobs, and whether a job is performed, and the information about the registered job may be updated based on whether the job is performed.

The controller may store information about a reserved job corresponding to a reservation request message in the storage unit when the reservation request message is received from the host apparatuses when the job is unregisterable; and the information about the reserved job may include at least one of a job type, an IP address of the host apparatus, port information, registered time, a requested using time, a total number of jobs, a number of remaining jobs, and whether a job is performed, and the information about the reserved job may be updated based on whether the job is performed.

The controller may transmit or receive a job event corresponding to the registered job to perform a corresponding job and may control the communication unit to transmit a use allowed message to a host apparatus corresponding to the reserved job.

The controller may control the communication unit to transmit a use allowed message to a host apparatus corresponding to the reserved job when a requested using time of the registered job is over. Further, the foregoing and/or other aspects may be achieved by providing at least one non-transitory computer readable medium including computer readable instructions that control at least one processor to implement a job performing method using target setup in an image forming apparatus supporting at least one function for targeting one host apparatus of a plurality of host apparatuses connected to the image forming apparatus via a network, the method including: receiving, by the host apparatus, input of a user generating a job event using a function by target setup supported by the image forming apparatus; transmitting, by the host apparatus, a use request message corresponding to the job event to the image forming apparatus; receiving, by the host apparatus, a message about whether to make a registration including whether a job targeting the host apparatus is registered in response to the use request message from the image forming apparatus; and displaying, by the host apparatus, whether the job event is registered based on the received message about whether to make the registration.

The foregoing and/or other aspects may be achieved by providing at least one non-transitory computer readable medium including computer readable instructions that control at least one processor to implement a job performing method using target setup in an image forming apparatus supporting at least one function for targeting one host apparatus of a plurality of host apparatuses connected to the image forming apparatus via a network, the method including: receiving, by the image forming apparatus, a use request message corresponding to a job event using a function by target setup supported by the image forming apparatus from the host apparatuses; determining, by the image forming apparatus, whether a job targeting the host apparatus is registerable corresponding to the received use request message; transmitting, by the image forming apparatus, a message about whether to make a registration including whether the job is registered to the host apparatus based on a result of the determination.

As described above, according to an image forming apparatus, a host apparatus, and a job performing method thereof, the image forming apparatus determines whether use is allowed based on a use request of the host apparatus to perform a job by target setup and transmits job data to the target host apparatus, so that a manipulation for target setup is not necessary in the image forming apparatus. Thus, a function using target setup may be simply used even in an image forming apparatus which does not have an LCD panel or includes a minimum number of input buttons.

Further, a target host apparatus is selected through a manipulation of a user-friendly host apparatus, and thus a user unfamiliar with a multiple user environment easily uses a function by target setup, and a host apparatus, even not pre-registered, is allowed to set up a target, improving convenience of users.

Moreover, a screen print may be used in a network environment.

In addition, when a function by target setup is registered by a user, a different user may make a reservation. The user making the reservation is informed when the registration of a job terminates, so that a plurality of users may use the function without inconvenience.

### BRIEF DESCRIPTION OF THE DRAWINGS

The above and/or other aspects will become apparent and more readily appreciated from the following description of the exemplary embodiments, taken in conjunction with the accompanying drawings, in which:

FIG. 1 is a block diagram illustrating a configuration of a network image forming system including a plurality of host apparatuses and an image forming apparatus according to an exemplary embodiment;

FIG. 2 illustrates a smart panel displayed to perform a job by target setup according to an exemplary embodiment;

FIG. 3 illustrates a control process of performing a job by target setup between a plurality of host apparatuses and an image forming apparatus according to an exemplary embodiment;

FIG. 4 illustrates a user interface (UI) to set up options of a job by target setup;

FIGS. 5 to 7 illustrate a notification window displayed according to an exemplary embodiment; and

FIGS. 8 and 9 are a flowchart illustrating a job performing method using target setup according to an exemplary embodiment.

### DETAILED DESCRIPTION

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity and conciseness, and like reference numerals refer to like elements throughout.

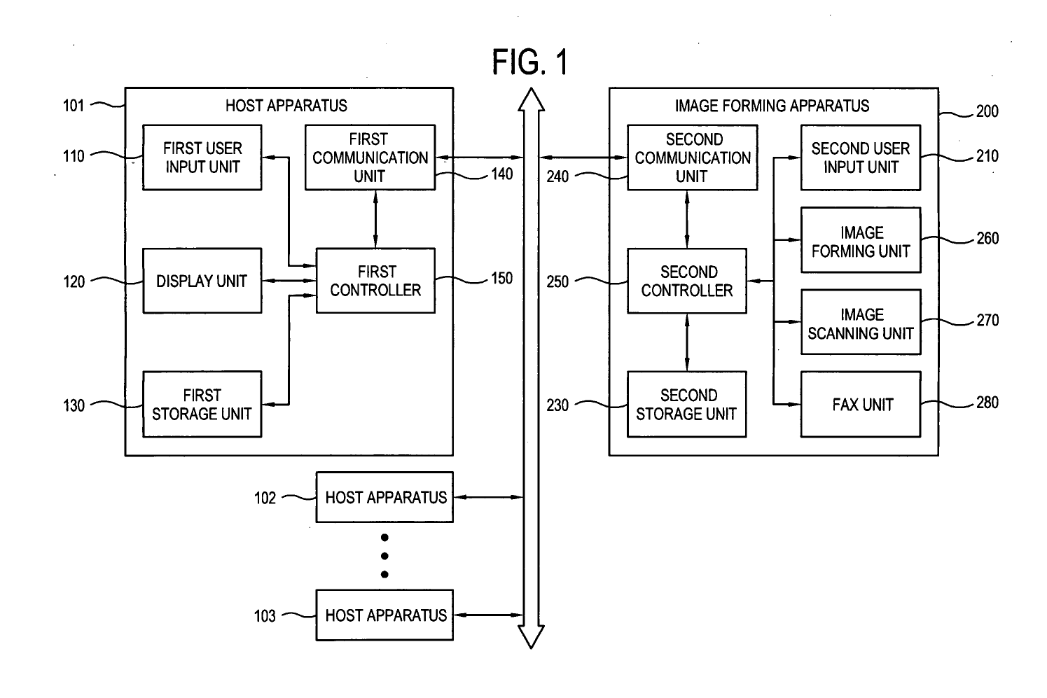

FIG. 1 is a block diagram illustrating a configuration of a network image forming system including a plurality of host apparatuses 101, 102, and 103 and an image forming apparatus 200 according to an exemplary embodiment.

The plurality of host apparatuses 101, 102, and 103 are configured as personal computers (PCs) and connected to the image forming apparatus 200 through a wire-based or wireless network to perform data communication with at least one image forming apparatus 200. The image forming apparatus 200 may be configured as a printer, a copy machine, a fax machine, a multi-functional device having at least two functions, or the like. Here, the image forming apparatus 200 of the present embodiment supports at least one function for any one target of the host apparatuses 101, 102, and 103.

As shown in FIG. 1, the host apparatuses 101, 102, and 103 include a first user input unit 110, a display unit 120, a first storage unit 130, a first communication unit 140, and a first controller 150.

The first user input unit 110 receives various selections from a user. In detail, the user selects one image forming apparatus 200 connected through the network as a target image forming apparatus and selects a function by target setup to be used with respect to the selected image forming apparatus 200 using the first user input unit 110. Here, the function by target setup may include at least one of a scan-to-PC and a screen print.

Here, the user may set up an option with respect to a job of the selected function using the first user input unit 110. The set up option may be a number of jobs, a requested using time, or the like.

Further, the first user input unit 110 may receive input for the user to select reservation of a job corresponding to a registration unallowable message and to select performance of a reserved job corresponding to a use allowed message. Further, the first user input unit 110 may receive input to delete a registration job or to extend a requested using time when the registration job is not performed and the requested using time is over.

The first user input unit 110 may receive a selection, from the user, to install software supporting use of a function by target setup of the image forming apparatus 200. Here, the installed software includes a printer driver or applications or solutions associated with the image forming apparatus 200.

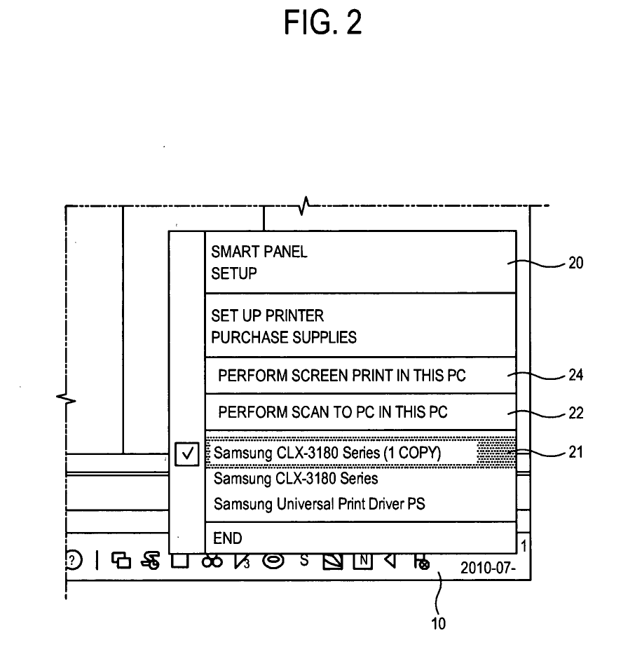

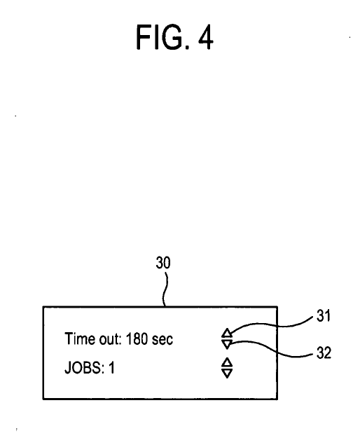

The first user input unit 110 includes a keyboard, a mouse, a touch panel, and the like, provided as an input device of the host apparatus 101, and may include a graphic user interface (GUI) generated by implementation of software, such as a driver, applications, and solutions, and displayed on the display unit 120 for the user to make a selection. For example, the first user input unit 110 of the present embodiment includes various menu items displayed on a smart panel 20 of FIG. 2 or an option setup user interface (UI) 30 of FIG. 4.

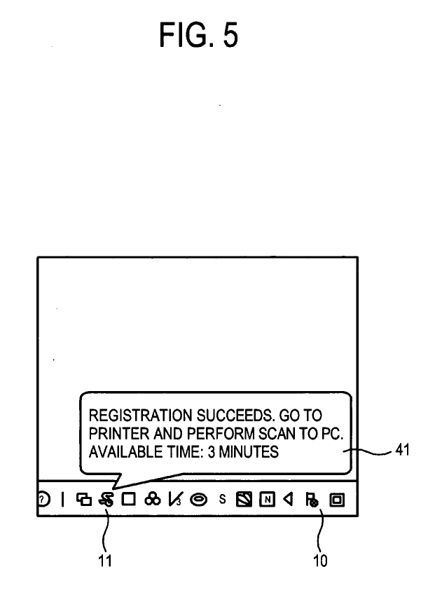

The display unit 120 displays, to the user, various notification windows shown in FIGS. 5 to 7 associated with the smart panel 20 to select a job by target setup, the option setup UI 30 of a job, whether to register a job event, whether a reservation is possible, and the like.

The display unit 120 may include a liquid crystal display (LCD) and a driver (not shown) to drive the LCD.

The first storage unit 130 stores job data generated by performance of a job by target setup and transmitted from the image forming apparatus 200. Here, the stored job data may include a scanned image data by a scan-to-PC.

The first storage unit 130 stores job data transmitted to the image forming apparatus 200 based on performance of a job by target setup. Here, the storage job data may include screen captured image data by a screen print.

The job data may further include information about software installed in the host apparatuses 101, 102, and 103, print data generated based on an instruction of the user and transmitted to the image forming apparatus 200, or the like.

The first storage unit 130 includes an internal storage medium installed in the host apparatuses 101, 102, and 103, such as a hard disk drive (HDD), and an external or portable storage medium, such as a universal serial bus (USB) memory, a memory card including a memory stick, a compact flash (CF) card, and a MultiMediaCard (MMC).

The first communication unit 140 performs data communication with the outside. The first communication unit 140 may include a wire-based or wireless communication module connectable to the image forming apparatus 200 via a network based on a protocol, or a communication interface, such as a USB.

In detail, the first communication unit 140 transmits a message to the image forming apparatus 200 to perform a job by target setup by the user and receives a message corresponding to the transmitted message from the image forming apparatus 200.

Here, the message transmitted to the image forming apparatus 200 includes a use request message and a reservation request message, and the message received from the image forming apparatus 200 includes a message about whether a registration is made including a registration allowable message and a registration unallowable message, and a use allowed message.

Further, the first communication unit 140 receives job data, for example, a scanned image, generated by completed performance of a registered job from the image forming apparatus 200 and transmits data used to perform a job, for example, a screen image of the target host apparatus 101, and print data generated based on a print instruction, to the image forming apparatus 200.

The first controller 150 controls the host apparatuses 101, 102, and 103 overall.

FIG. 2 illustrates the smart panel 20 displayed to perform a job by target setup according to an exemplary embodiment.

The first controller 150 installs software in the host apparatus 101 when the software supporting use of a function by target setup of the image forming apparatus 200 is selected to be installed by the user through the first user input unit 110. Here, the installed software includes a printer driver or applications or solutions associated with the image forming apparatus 200.

The user implements the installed software through the first user input unit 110 and may add at least one image forming apparatus 200 to be used through the installed software among image forming apparatuses shared via a network.

When the at least one image forming apparatus 200 is added in the installed software, the first controller 150 controls the display unit 120 to display a menu 21 to select the added image forming apparatus 200 in the smart panel 20, as shown in FIG. 2.

Here, the smart panel 20 may be displayed by clicking a right button of a mouse on an icon 11 displayed on a taskbar 10 corresponding to the installed software in FIG. 2.

When the user selects one 21 of image forming apparatuses 200 added to the smart panel 20, the first controller 150 displays function items 22 and 24 by target setup supported by the selected image forming apparatus 200 to be selected.

The user may select a function to perform among the function items 22 and 24 displayed on the smart panel 20. Although the function items shown in FIG. 2 includes only a scan-to-PC and a screen print, a function by target setup in the present embodiment may include any function for a particular target host apparatus among various functions supported by the image forming apparatus 200.

Here, the first controller 150 may include a registration performing unit, a response processing unit, and an event processing unit. The registration performing unit receives a request from the user to register the host apparatus 101 with respect to a job corresponding to a function by target setup supported by the image forming apparatus 200 and transmits the request to the image forming apparatus 200. The response processing unit receives and processes a response of the image forming apparatus 200 to the registration and feeds the response back to the user. The event processing unit transmits and receives a job event used when the image forming apparatus 200 performs a registered job to perform a corresponding operation after completion of the registration.

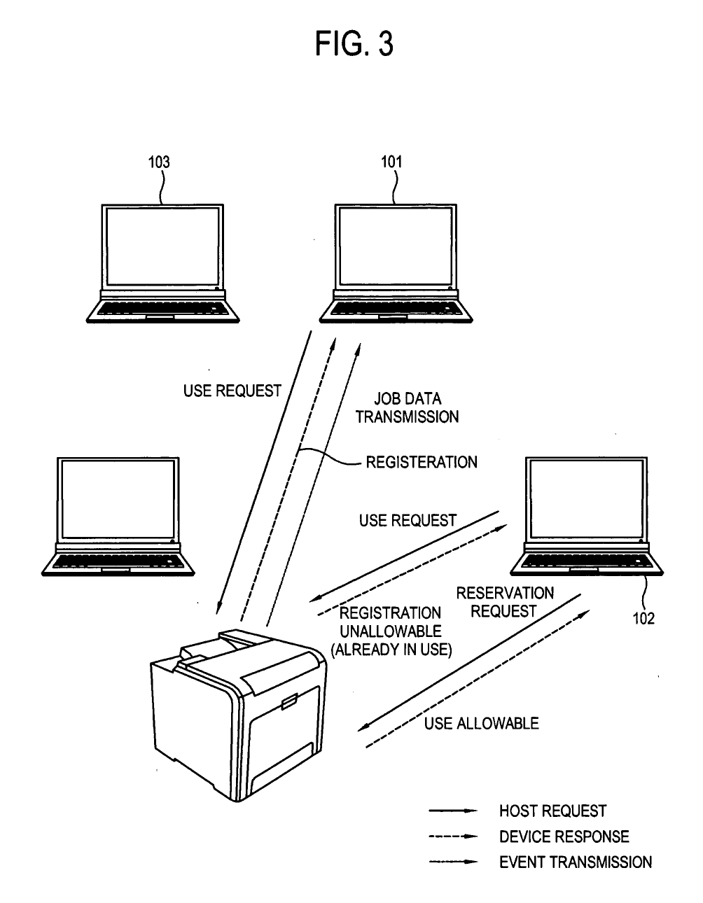

FIG. 3 illustrates a process of controlling performance of a job by target setup between the plurality of host apparatuses 101, 102, and 103 and the image forming apparatus 200 according to an exemplary embodiment.

The user may select any one to perform, for example, a scan-to-PC 22, among the function items 22 and 24 displayed on the smart panel 20 shown in FIG. 2.

Hereinafter, a case where the host apparatus 101 uses a scan-to-PC is described as an example of performing a job by target setup, and the performance of the job may be also realized by the other host apparatuses 102 and 103 in the same manner.

The first controller 150 controls the first communication unit 140 to transmit a use request message corresponding to a job event to the image forming apparatus 200 in response to a user's selection of a job event by target setup, and to receive a message about whether registration is made including whether a corresponding job is registered from the image forming apparatus 200.

Here, the messages transmitted and received between the host apparatus 101 and the image forming apparatus 200 have an Extensible Markup Language (XML) format and may distinguish information including a message type, a job type, or the like through a tag.

For example, the use request message may include at least one of a job type, user information, an IP address of the host apparatus, port information, a number of jobs, and a requested using time, shown as follows.

<root>
<Scan2PC Type=“Registration” UserID=“com-id”
Address=“10.88.193.23” Port=“23414” />
</root>

The above use request message denotes the host apparatus 101 having an IP address of 10.88.193.23 requests use of a scan-to-PC (Scan2PC) using a port 23414.

Here, the use request message may further include option information, such as a number of jobs and a requested using time, shown as follows.

<root>
<Scan2PC Type=“Registration” Address=“10.88.193.23” Port=“23414”
TimeOut=“180” Job=“1” />
</root>

The above use request message denotes the host apparatus 101 having an IP address of 10.88.193.23 requests use of one scan-to-PC (Scan2PC) for 180 seconds using a port 23414.

Here, the first controller 150 controls the display unit 120 to generate and display the option setup UI 30 so the user makes a selection.

FIG. 4 illustrates the option setup UI 30 of a job by target setup.

As shown in FIG. 4, the user selects a requested using time, that is, a timeout of a job event, and sets up a number of jobs using up and down arrow keys 31 and 32 of the option setup UI 30.

As described above, it is possible for the user to set up the timeout for use and the number of jobs, and thus the user does not need to make several trips between the host apparatus 101 and the image forming apparatus 200 to register a plurality of jobs.

Here, the first controller 150 may control the display unit 120 to display a requested using time of 180 seconds and a number of jobs of one as a preset default option, as shown in FIG. 4, and the default option may be changed. Further, the default option has a limit, for example, less than ten minutes, so that a particular user is not allowed to occupy the image forming apparatus 200 for an excessively long time.

A message about whether a registration is made is transmitted from the image forming apparatus 200 through the first communication unit 140 corresponding to a use request message, and includes a tag expressing a job type and whether it is possible to register a job of a use message (REGI_OK or REGI_FAIL).

<root>
<Scan2PC Result=“REGI_OK” />
</root>

FIGS. 5 to 7 illustrate notification windows 41, 42, and 43 displayed according to an exemplary embodiment.

The first controller 150 controls the display unit 120 to display a notification window 41 reporting that a registration succeeds, shown in FIG. 5, when a registration allowable message is received. Here, the registration success notification window 41 may also display an available time of a corresponding job, as shown in FIG. 5.

Here, when a use requested job is unregisterable, the following registration unallowable message is received through the first communication unit 140.

<root>
<Scan2PC Result=“REGI_FAIL”
Reason=““REGIST_BY_OTHER_USER” >
<User IP=“10.88.194.114” TimeOut=“180” RemainedJob=“1”/>
<User IP=“10.88.193.100” TimeOut=“300” RemainedJob=“1”/>
</Scan2PC>
</root>

Here, the above registration unallowable message includes a tag, which is a reason, expressing a reason why the registration is impossible, for example, network connection failure, presence of another pre-registered user, or the like, and may further include information about a pre-registered user, for example, an IP address, a registered using time, and a number of remaining jobs.

Referring to FIG. 3, in a state that the host apparatus 101 transmits a use request message with respect to a scan-to-PC and receives a use allowed message, when the host apparatus 102 transmits a use request message with respect to a scan-to-PC or a screen print, the host apparatus 102 receives a use unallowable message from the image forming apparatus 200.

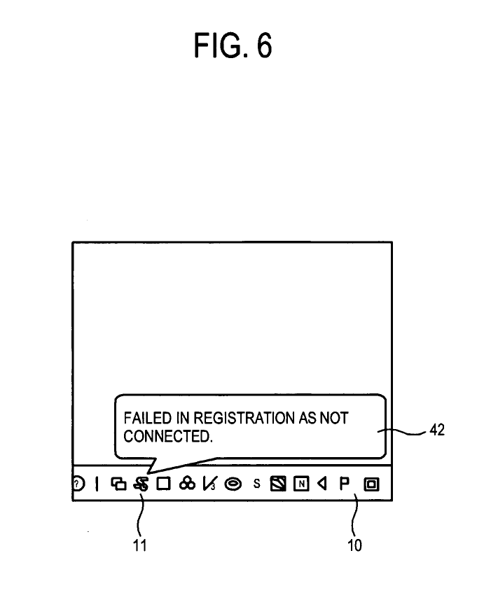

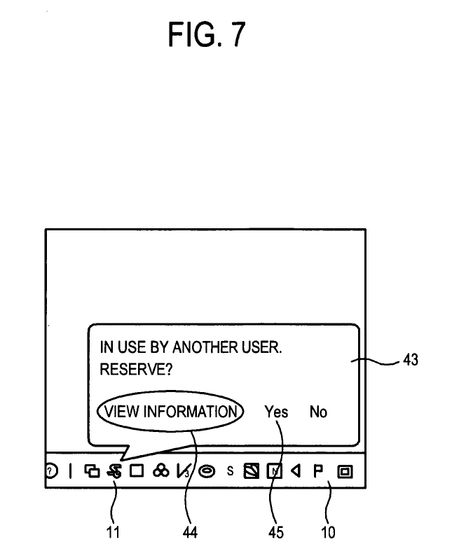

When the registration unallowable message is received, the first controller 150 controls the display unit 120 to display notification windows 42 and 43 explaining a reason why the registration is impossible, as shown in FIGS. 6 and 7.

That is, when a registration unallowable message is received due to network connection failure, a notification window 42 explaining the reason is displayed, as shown in FIG. 6.

Here, the notification window 42 shown in FIG. 6 may further include an icon to enable the user to select whether to resend the use request message. The first controller 150 may control the first communication unit 140 to resend the use request message to the image forming apparatus 200 based on a user's selection.

Further, when a registration of a job is impossible due to another pre-registered job, a notification window 43 reporting about this is displayed, as shown in FIG. 7.

Here, the notification window 43 shown in FIG. 7 may further include a registered job information confirmation icon 44 and an icon 45 to enable the user to select whether to make a reservation. The first controller 150 may control the first communication unit 140 to transmit a reservation request message to the image forming apparatus 200 based on a user's selection.

When the user selects the job information conformation icon 44, the first controller 150 receives information about a registered job from the image forming apparatus 200 through the first communication unit 140 and displays the received information about the registered job, for example, an IP address of a registered user, a number of jobs, a remaining time of job, or the like on the display unit 120.

The user identifies the information about the registered job, and selects whether to reserve a job to perform or to use another image forming apparatus 200.

The reservation request message has an XML format, distinguishing a message type, which indicates a reservation, through a tag as follows, and may include at least one of a job type, user information, an IP address of the host apparatus, and port information.

<root>
<Scan2PC Type=“Reservation” UserID=“com-id”
Address=“10.88.193.133” Port=“23414” />
</root>

That is, the above reservation request message denotes the host apparatus 102 having an IP address of 10.88.193.133 requests a reservation of a scan-to-PC (Scan2PC) using a port 23414.

Further, like the use request message, the reservation request message may further include at least one of a number of jobs to reserve and a requested using time.

As shown in FIG. 3, when the use request message is received, the image forming apparatus 200 determines whether to allow a registration of a job and transmits a message about whether the registration is made to the host apparatus 101. Further, the image forming apparatus 200 transmits a job event to the corresponding host apparatus 101 based on performance of the registered job. Also, when there is a reserved job, the image forming apparatus 200 transmits a use allowed message to the host apparatus 102 making a reservation when a registration process is completed.

Referring to FIG. 1, the image forming apparatus 200 includes an image forming unit 260, a second user input unit 210, a second storage unit 230, a second communication unit 240, and a second controller 250. When the image forming apparatus 200 is a multi-functional device having at least two functions, the image forming apparatus 200 may further include an image scanning unit 270 and a fax unit 280, as shown in FIG. 1.

The image forming unit 260 forms an image printed on at least one recording medium (paper) based on print data under a printing instruction. Here, printing includes printing a scanned document for copy, printing received fax data, and printing data received from the outside via the host apparatuses 101, 102, and 103 including a server or stored in the HDD of the image forming apparatus 200 or in an external memory, such as a USB memory. In the present embodiment, the image forming unit 260 includes a developing unit including an image carrying member, a light scanning unit, a transfer unit, and a fixing unit.

The image forming apparatus 200 of the present embodiment includes an one-color image forming apparatus using a single-color developing agent, generally black, to form an image, a color image forming apparatus using four colors of developing agents to form a color image, and a multiple-color image forming apparatus using four colors of developing agents and a white developing agents as a supplement developing agent to form a color image.

The image scanning unit 270 scans a document (a scanning material) to be scanned to generate scan data. The document to be scanned includes a document, a photo, a film, or the like. The image scanning unit 270 may include an optical converter formed of charge-coupled device (CCD), contact or CMOS image sensor (CIS), or the like, and an image processor processing a document into image data using a signal output from the optical converter. Further, the image scanning unit 270 may further include a scan motor driving the optical converter and the image processor and a guide.

Meanwhile, scan data scanned by the image scanning unit 270 may be converted into a fax signal to be transmitted by the fax unit 280 to an external fax machine.

The fax unit 280 may include a fax communication module, for example, a modem, which changes image data generated by the image scanning unit 270 into a fax signal and transmits the fax signal to an external fax machine including a multifunctional device with a faxing function via the public switched telephone network (PSTN), or receives a fax signal from an external fax machine.

The second user input unit 210 receives input of data or instructions from the user. The second user input unit 210 includes input buttons provided in the image forming apparatus 200.

The user manipulates the second user input unit 210 to perform a job in the image forming apparatus 200, the job corresponding to a registered job message received from the host apparatus 101.

The image forming apparatus 200 of the present embodiment may not include a display unit, such as an LCD panel, but include only a limited number of input buttons.

The second storage unit 230 stores various printing data for printing, fax data for faxing, scanned image data by the image scanning unit 270, data received from an external device including the host apparatuses 101, 102, and 103 and a server connected through the second communication unit 250, various types of setup information about the image forming apparatus 200 through the second user input unit 210, user authentication information about each user account, use authority information, or the like. Further, the second storage unit 230 may further store fax data received from an external fax machine through the fax unit 280.

The second storage unit 230 of the image forming apparatus 200 of the present embodiment includes a job administration unit to administer information about jobs corresponding to a use request message and a reservation request message received from the host apparatuses 101, 102, and 103.

The second storage unit 230 includes an internal storage medium, such as an HDD, an external or portable storage medium, such as a USB memory, a memory card including a memory stick, a CF card, and an MMC, and a memory card slot.

The second communication unit 240 performs data communication with an external device including the host apparatuses 101, 102, and 103 and a server and receives printing data formed of printing languages from the outside.

The second communication unit 240 of the image forming apparatus 200 of the present embodiment receives a use request message, a reservation request message, or the like from the host apparatuses 101, 102, and 103 and transmits, to the host apparatuses 101, 102, and 103, a message about whether a registration is made indicating that a registration is allowable or unallowable based on whether a job is registered or not.

Further, the second communication unit 240 transmits a job event by performance of a job by target setup to the corresponding host apparatus 101 and transmits a use allowed message to the host apparatus 102 associated with a reserved job.

The second communication unit 240 may include a wire-based or wireless communication module connectable to an external device, such as the host apparatuses 101, 102, and 103, via a network based on a protocol, or an interface connected to a portable storage medium including a USB memory, for example, a UBS port.

The second controller 250 controls the image forming apparatus 200 overall.

In detail, when a use request message corresponding to a job event using a function by target setup supported by the image forming apparatus 200 is received through the second communication unit 240 from one host apparatus 101 among the plurality of the host apparatuses 101, 102, and 103, the second controller 250 determines whether to allow a registration of a job for the target host apparatus 101 corresponding to the received use request message and stores information about the job in the job administration unit of the second storage unit 240.

Here, the second controller 250 may include a registration response unit, a registration administration unit, and an event transmission unit. The registration response unit determines whether a registration is allowable and generates a response when a registration request is received from a host apparatus 101. The registration administration unit administers information stored in the job administration unit for a timeout, a reservation notification, and transmission of a job event with respect to the received registration request. The event transmission unit performs transmission and reception of an event when the user performs a registered job in the image forming apparatus 200.

Tables 1 to 3 illustrate an example of the job administration unit of the second storage unit 240.

TABLE 1

| | | | Requested | | | Job |
|---|---|---|---|---|---|---|
| | | | using time/ | | | currently |
| | | Registered | Time out | Total | Remaining | being |
| | IP/Port | time | (sec) | jobs | jobs | performed |
| Registered | 10.88.194.114 | 2010.07.19 | 180 | 3 | 3 | No |
| job | | 12:12:13 | | | | |
| Reserved | | | | | | |
| job | | | | | | |

As shown in Table 1, the job administration unit may store information about a job of one host apparatus 101 in a registered job, and may store and administer information about a job of at least one host apparatus in a reserved job.

For example, in a state that there is no job registered or reserved, when a use request message to perform three scan-to-PC jobs for 180 seconds is received from the host apparatus 101 having an IP address of 10.88.194.114, the second controller 250 stores a job event corresponding to the received use request message in the job administration unit as a registered job.

Here, as shown in Table 1, information about the registered job includes at least one of a job type, an IP address of the host apparatus 101, port information, registered time, a requested using time, a total number of jobs, a number of remaining jobs, and whether a job is performed, and each of the information is administered in a field.

When the registered job is completely stored, the second controller 250 controls the second communication unit 240 to transmit a registration allowable message to the corresponding host apparatus 101.

TABLE 2

| | | | Requested | | | Job |
|---|---|---|---|---|---|---|
| | | | using time/ | | | currently |
| | | Registered | Time out | Total | Remaining | being |
| | IP/Port | time | (sec) | jobs | jobs | performed |
| Registered | 10.88.194.114 | 2010.07.19 | 180 | 3 | 1 | Yes |
| job | | 12:12:13 | | | | |
| Reserved | | | | | | |
| job | | | | | | |

The registered job stored in the job administration unit is updated based on whether the image forming apparatus 200 performs the job, as shown in Table 2. That is, the number of remaining jobs is changed based on whether the job is performed.

TABLE 3

| | | | Requested | | | Job |
|---|---|---|---|---|---|---|
| | | | using time/ | | | currently |
| | | Registered | Time out | Total | Remaining | being |
| | IP/Port | time | (sec) | jobs | jobs | performed |
| Registered | 10.88.194.114 | 2010.07.19 | 180 | 3 | 1 | Yes |
| job | | 12:12:13 | | | | |
| Reserved | 10.88.193.100. | 2010.07.19 | 300 | 1 | 1 | No |
| job | | 12:14:22 | | | | |

As shown in Table 3, in a state that there is a registered job, when a use request message to perform one scan-to-PC job for 300 seconds is received from the host apparatus 102 having an IP address of 10.88.194.100, the second controller 250 controls the second communication unit 240 to transmit a registration unallowable message to the host apparatus 102 and stores a job event corresponding to a received reservation request message in the job administration unit as a reserved job.

Here, as shown in Table 3, information about the reserved job includes at least one of a job type, an IP address of the host apparatus 102, port information, registered time, requested using time, a total number of jobs, a number of remaining jobs, and whether a job is performed.

When all registered jobs are completed, shown in FIG. 3, the second controller 250 transmits a job event corresponding to a completed registered job, for example, scanned image data by a scan-to-PC, to the corresponding host apparatus 101, controls the second communication unit 240 to report that the job terminates, and updates the job administration unit.

Here, when there is a reserved job, the second controller 250 transfers the reserved job to a field of a registered job and controls the second communication unit 240 to transmit a use allowed message indicating that the reserved job is allowed to be performed to the host apparatus 102 corresponding to the reserved job.

When a registered job is a screen printing job, the second controller 250 receives a captured screen image of the corresponding host apparatus 101 as a job event and controls the image forming unit 260 to print the screen image.

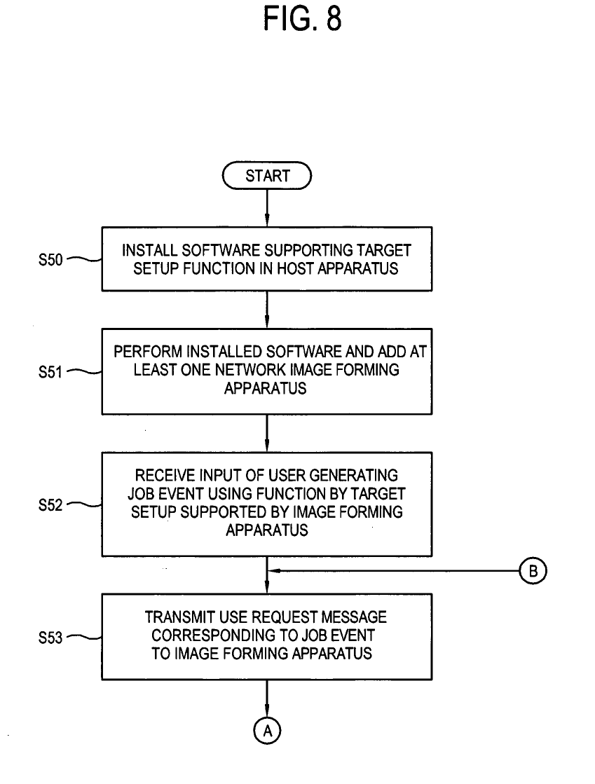

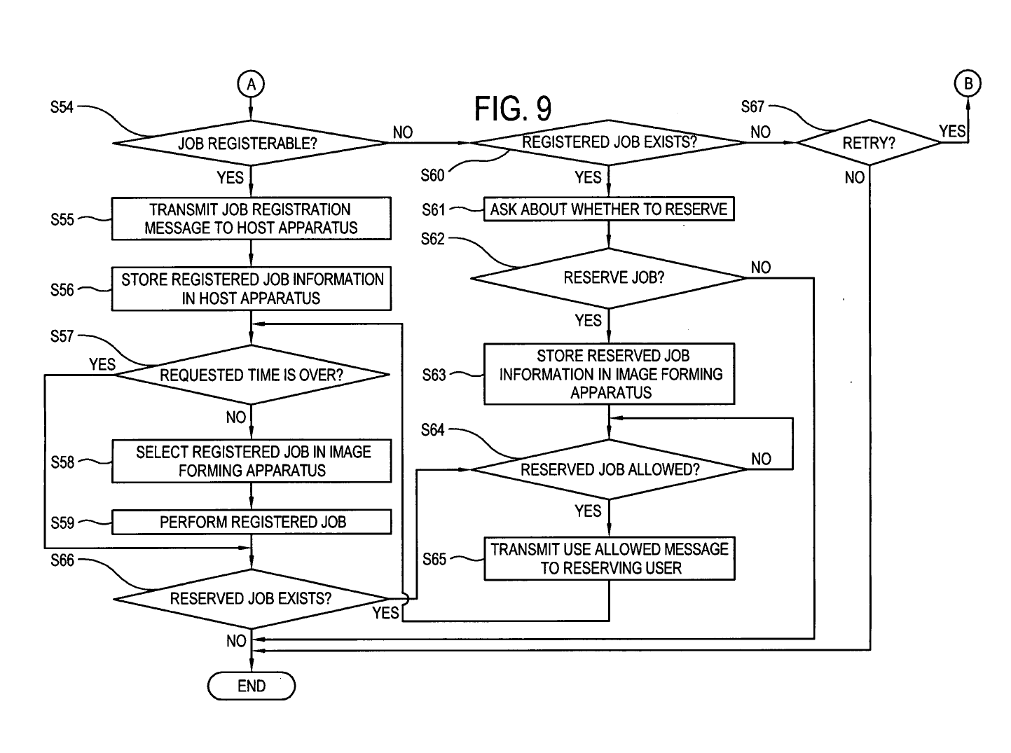

Hereinafter, in the host apparatuses and the image forming apparatus, a job performing method using target setup described above is described with reference to FIGS. 8 and 9.

FIGS. 8 and 9 are flowcharts illustrating a job performing method using target setup according to an exemplary embodiment.

As shown in FIG. 8, the user may install software supporting a target setup function of the image forming apparatus 200 in at least one host apparatus 101 among the plurality of host apparatuses 101, 102, and 103 (S50).

The user performs the software installed in operation S50 using the first user input unit 110 and adds at least one image forming apparatus 200 in a network (S51).

The user selects a function by target setup supported by the image forming apparatus 200 added in operation S51 using the first user input unit 110 (S52). Here, the first controller 150 may generate a job event using the selected function.

The host apparatus 101 transmits a use request message corresponding to the job event in operation S52 to the image forming apparatus 200 (S53). Here, the use request message may include an XML file including a tag indicating a job type, user information, an IP address of the host apparatus, port information, a number of jobs, and a requested using time.

As shown in FIG. 9, the image forming apparatus 200 determines whether a registration of a job corresponding to the use request message received in operation S53 is allowable (S54).

As a result of the determination in operation S54, when the registration is allowable, the image forming apparatus 200 transmits a registration allowable message to the host apparatus 101 (S55). The registration allowable message may include an XML file including a tag indicating whether the registration is allowable.

Then, the image forming apparatus 200 stores information about the job corresponding to the received use request message in operation S54 in the second storage unit 230 (S56). Here, the stored information about the job includes information in each field, shown in Tables 1 to 3, and is updated based on whether the job is performed.

The image forming apparatus 200 determines whether a requested using time of the registered job is over based on the information about the job stored in operation S56 (S57).

The user identifies the job registered notification window 41 based on a job registered message transmitted in operation S55 through the host apparatus 101, and selects a registered job, for example, a scan-to-PC or a screen print, in the image forming apparatus 200 within the requested using time (S58).

The second controller 250 performs the job selected in operation S58 (S59). Here, when the selected job is a scan-to-PC, the second controller 250 controls the image scanning unit 270 to scan an image of a document to scan and to generate a scanned image, and controls the second communication unit 240 to transmit the generated scanned image to the target host apparatus 101. When the selected job is a screen print, the second controller 250 receives a captured screen image of the target host apparatus 101 through the second communication unit 240 and controls the image forming unit 260 to print the received screen image. Here, transmitting the scanned image to the target host apparatus 101 or receiving the captured screen image denotes transmitting or receiving a job event of the registered job.

As a result of the determination in operation S54, when the registration is not allowed, the second controller 250 determines whether there is a registered job in the registration administration unit of the second storage unit 230 (S60).

When there is a registered job in operation S60, the image forming apparatus 200 transmits a registration unallowable message to the host apparatus 101, and the host apparatus 101 displays the notification window 43 to ask the user about whether to reserve the job (S61).

The user may select whether to reserve the job in response to the notification window 43 displayed in operation S61 (S62).

When the user selects reservation of the job in operation S62, the host apparatus 101 transmits a reservation request message to the image forming apparatus 200, and the image forming apparatus 200 stores information about a reserved job corresponding to the received reservation request message in the job administration unit (S63).

Then, the second controller 250 determines whether the stored reserved job is allowable (S64).

When the reserved job is determined to be allowable in operation S64, the image forming apparatus 200 transmits a use allowed message to the host apparatus 101 corresponding to the reserved job (S65). Here, the second controller 250 updates the job administration unit so that the reserved job becomes a registered job.

The user identifies the use allowed message in the host apparatus 101 and performs a registered job as shown in operations S57 to S59.

When performance of the registered job terminates in operation S59, the image forming apparatus 200 may determine whether there is a reserved job in the job administration unit (S66).

When there is a reserved job in operation S66, the second controller 250 performs operations S64 and operation S65 to perform at least one reserved job properly.

Meanwhile, when there is no registered job in operation S60, that is, when a registration of a job is not allowed in a state that there is no registered job, for example, in network connection failure, the image forming apparatus 200 transmits a registration unallowable message to the host apparatus 101, and the user may select whether to retry a use request message (S67).

When the user selects a retry in operation S67, the host apparatus 101 transmits a use request message to the image forming apparatus 200 again (S53).

The above present embodiment is described with a scan-to-PC and a screen print as an example of a function by target setup of the image forming apparatus 200, but is not limited thereto. The present embodiment may be applied to any function of the image forming apparatus 200 using a target device.

The foregoing and/or other aspects are also achieved by providing at least one non-transitory computer readable medium including computer readable instructions that control at least one processor to implement methods of one or more embodiments.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. A job performing method using target setup in an image forming apparatus supporting at least one function for targeting one host apparatus of a plurality of host apparatuses connected to the image forming apparatus via a network, the method comprising:
receiving, by the host apparatus, input of a user generating a job event using a function by target setup supported by the image forming apparatus;
transmitting, by the host apparatus, a use request message corresponding to the job event to the image forming apparatus;
receiving, by the host apparatus, a message about whether to make a registration including whether a job targeting the host apparatus is registered in response to the use request message from the image forming apparatus; and
displaying, by the host apparatus, whether the job event is registered based on the received message about whether to make the registration.

2. The method of claim 1, wherein the use request message comprises at least one a job type, user information, an IP address of the host apparatus, port information, a number of jobs, and a requested using time.

3. The method of claim 1, wherein the function by target setup comprises at least one of a scan-to-PC and a screen print.

4. The method of claim 1, further comprising displaying, by the host apparatus, a notification window to ask about whether to reserve the job when the job is unregisterable.

5. The method of claim 4, further comprising receiving, by the host apparatus, a selection of the user in response to the notification window to ask about whether to reserve the job; and transmitting, by the host apparatus, a reservation request message to the image forming apparatus based on the selection of the user.

6. A job performing method using target setup in an image forming apparatus supporting at least one function for targeting one host apparatus of a plurality of host apparatuses connected to the image forming apparatus via a network, the method comprising:
receiving, by the image forming apparatus, a use request message corresponding to a job event using a function by target setup supported by the image forming apparatus from the host apparatuses;
determining, by the image forming apparatus, whether a job targeting the host apparatus is registerable corresponding to the received use request message;
transmitting, by the image forming apparatus, a message about whether to make a registration including whether the job is registered to the host apparatus based on a result of the determination.

7. The method of claim 6, further comprising storing, by the image forming apparatus, information about a registered job when the job is registerable, wherein the information about the registered job comprises at least one of a job type, an IP address of the host apparatus, port information, registered time, a requested using time, a total number of jobs, a number of remaining jobs, and whether a job is performed and the information about the reserved job is updated based on whether the job is performed.

8. The method of claim 7, further comprising receiving, by the image forming apparatus, the reservation request message when the job is not registerable; and storing, by the image forming apparatus, information about a reserved job corresponding to the received reservation request message, wherein the information about the reserved job comprises at least one of a job type, an IP address of the host apparatus, port information, registered time, a requested using time, a total number of jobs, a number of remaining jobs, and whether a job is performed and the information about the reserved job is updated based on whether the job is performed.

9. The method of claim 8, further comprising transmitting a job event corresponding to the registered job and performing a corresponding job.

10. The method of claim 9, further comprising transmitting, by the image forming apparatus, a use allowed message to the host apparatus corresponding to the reserved job when performance of the registered job terminates.

11. The method of claim 9, further comprising transmitting, by the image forming apparatus, a use allowed message to the host apparatus corresponding to the reserved job when a requested using time of the registered job is over.

12. A host apparatus connected via a network to an image forming apparatus supporting at least one function for targeting one of a plurality of host apparatuses, the host apparatus comprising:
a communication unit which performs network communication with the image forming apparatus;
a user input unit which receives input of a user generating a job event using a function by target setup supported by the image forming apparatus;
a display unit; and
a controller which transmits a use request message corresponding to the job event to the image forming apparatus, controls the communication unit to receive, from the image forming apparatus, a message about whether to make a registration including whether a job targeting the host apparatus is registered in response to the use request message, and controls the display unit to display whether the job event is registered based on the received message about whether to make the registration.

13. The host apparatus of claim 12, wherein the use request message comprises at least one a job type, user information, an IP address of the host apparatus, port information, a number of jobs, and a requested using time.

14. The host apparatus of claim 12, wherein the function by target setup comprises at least one of a scan-to-PC and a screen print.

15. The host apparatus of claim 12, wherein the display unit displays a notification window to ask about whether to reserve the job when the job is unregisterable, the user input unit receives a selection of the user in response to the notification window to ask about whether to reserve the job, and the controller controls the communication unit to transmit a reservation request message to the image forming apparatus based on the selection of the user.

16. An image forming apparatus supporting at least one function for targeting one of a plurality of host apparatuses and performing network communication with the plurality of host apparatuses, the image forming apparatus comprising:
a communication unit which receives, from the host apparatuses, a use request message corresponding to a job event using a function by target setup supported by the image forming apparatus; and
a controller which determines whether a job targeting the host apparatuses is registerable corresponding to the received use request message, and controls the communication unit to transmit, to the host apparatuses, a message about whether to make a registration including whether the job is registered based on a result of the determination.

17. The image forming apparatus of claim 16, further comprising a storage unit to store job information, wherein the controller stores information about a registered job corresponding to the received use request message in the storage unit when the job is registerable.

18. The image forming apparatus of claim 17, wherein the information about the registered job comprises at least one of a job type, an IP address of the host apparatuses, port information, registered time, a requested using time, a total number of jobs, a number of remaining jobs, and whether a job is performed, and the information about the registered job is updated based on whether the job is performed.

19. The image forming apparatus of claim 17, wherein the controller stores information about a reserved job corresponding to a reservation request message in the storage unit when the reservation request message is received from the host apparatuses when the job is unregisterable; and the information about the reserved job comprises at least one of a job type, an IP address of the host apparatus, port information, registered time, a requested using time, a total number of jobs, a number of remaining jobs, and whether a job is performed, and the information about the reserved job is updated based on whether the job is performed.

20. The image forming apparatus of claim 19, wherein the controller transmits or receives a job event corresponding to the registered job to perform a corresponding job and controls the communication unit to transmit a use allowed message to a host apparatus corresponding to the reserved job.

21. The image forming apparatus of claim 19, wherein the controller controls the communication unit to transmit a use allowed message to a host apparatus corresponding to the reserved job when a requested using time of the registered job is over.

22. At least one non-transitory computer readable medium comprising computer readable instructions that control at least one processor to implement a job performing method using target setup in an image forming apparatus supporting at least one function for targeting one host apparatus of a plurality of host apparatuses connected to the image forming apparatus via a network, the method comprising:
receiving, by the host apparatus, input of a user generating a job event using a function by target setup supported by the image forming apparatus;
transmitting, by the host apparatus, a use request message corresponding to the job event to the image forming apparatus;
receiving, by the host apparatus, a message about whether to make a registration including whether a job targeting the host apparatus is registered in response to the use request message from the image forming apparatus; and
displaying, by the host apparatus, whether the job event is registered based on the received message about whether to make the registration.

23. At least one non-transitory computer readable medium comprising computer readable instructions that control at least one processor to implement a job performing method using target setup in an image forming apparatus supporting at least one function for targeting one host apparatus of a plurality of host apparatuses connected to the image forming apparatus via a network, the method comprising:
receiving, by the image forming apparatus, a use request message corresponding to a job event using a function by target setup supported by the image forming apparatus from the host apparatuses;
determining, by the image forming apparatus, whether a job targeting the host apparatus is registerable corresponding to the received use request message;
transmitting, by the image forming apparatus, a message about whether to make a registration including whether the job is registered to the host apparatus based on a result of the determination.
